(19) United States
(12) Patent Application Publication
(10) Pub. No.: US 2007/0223500 A1
(43) Pub. Date: Sep. 27, 2007

(54) Home Network System

(75) Inventors: Koon-Seok Lee, Kyungsangnam-do (KR); Seung-Myun Baek, Kyungsangnam-do (KR); Hwang-Jong Choi, Busan (KR); Yong-Tac Kim, Kyungsangnam-do (KR); Fecl-Young Koo, Busan (KR); Ja-In Koo, Kyungsangnam-do (KR); Scong-Hwan Kang, Kyungsangnam-do (KR)

Correspondence Address: MCKENNA LONG & ALDRIDGE LLP, 1900 K STREET, NW, WASHINGTON, DC, 20006, US

(73) Assignee: LG Electronics Inc., Yongdungpo-ku, Seoul (KR)

(21) Appl. No.: 10/558,438

(22) PCT Filed: Jul. 7, 2003
(86) PCT No.: PCT/KR03/01343

§ 371 Date: Mar. 19, 2007

(30) Foreign Application Priority Data
May 30, 2003 (KR) 10-2003-0034962

(51) Int. Cl. H04L 12/28

(52) U.S. Cl. 370/401

(57) ABSTRACT

The present invention discloses a home network system (40) which can provide a predetermined control protocol for connecting various home networks (46,48) for communication. The home network system (40) includes a first network (46), a second network (48) separated from the first network (46,48), a home appliance connectable to at least one of the first and second networks, and a network manager (22) connectable to at least one of the first and second networks (46,48), for controlling and monitoring the home appliance.

### TECHNICAL FIELD

The present invention relates to a home network system, and more particularly to, a home network system which can provide a predetermined control protocol for connecting various home networks for communication.

### BACKGROUND ART

Home automation for automatically controlling home appliances at home or remotely has almost reached a commercial use stage. At its early stage, the home automation separately controlled each home appliance by using a telephone or infrared rays, and did not connect the home appliances one another. However, there has been suggested a method for building a network of home appliances by using a communication means, and collectively managing the network by using a controller.

FIG. 1 is a structure view illustrating a general home network system. Referring to FIG. 1, a home network connects various digital home appliances so that a user can always enjoy convenient, safe and economic life services inside or outside the house.

As factors of the advent of the home network, refrigerators or washing machines called white home appliances have been gradually digitalized due to development of digital signal processing techniques, and new information home appliances have been made due to rapid development of home appliance operating system techniques and high speed multimedia communication techniques.

Here, an IT network is built to exchange data between a personal computer and peripheral devices or provide internet services, and an AV network is built between home appliances using audio or video information. In addition, a living network is built to simply control home appliances, such as home automation or remote meter reading, and may be comprised of a refrigerator, washing machine, microwave oven, electric lamp, gas alarm, air conditioner and telephone.

The home appliances for the IT network or AV network service require high function hardware specifications as well as a protocol for a high data rate and high speed communication. Conversely, the living network service is mostly intended to perform small data transmission for remote control or operation status monitoring, and thus requires a protocol using minimum resources.

### DISCLOSURE OF THE INVENTION

An object of the present invention is to provide a home network executed under a predetermined control protocol using minimum resources in a living network as well as an IT network and an AV network.

Another object of the present invention is to provide a home network system which can connect a plurality of networks for connecting various home appliances, and optimally control the home appliances under a predetermined control protocol.

In order to achieve the above-described objects of the invention, there is provided a home network system including: a first network; a second network separated from the first network; a home appliance connectable to at least one of the first and second networks; and a network manager connectable to at least one of the first and second networks, for controlling and monitoring the home appliance.

Preferably, the home appliance and the network manager each respectively include a first interface module based on a predetermined control protocol connectable to the first network, for transmitting/receiving a message to/from an inside control means.

Preferably, the home appliance and the network manager each respectively include a second interface module based on the control protocol connected to the first interface module and connectable to the second network.

Preferably, the home appliance and the network manager are connected to each other through the first network by the first interface module, or through the second network by the first and second interface modules.

Preferably, the first and second interface modules each respectively include an application layer using the message, a network layer, a data link layer and a physical layer under the control protocol, and the data link layers each respectively include a universal asynchronous receiver and transmitter for connecting the first interface module to the second interface module.

Preferably, the home appliance includes: a first interface module for transmitting/receiving a message to/from an inside control means; and a second interface module based on a predetermined control protocol connected to the first interface module and connectable to the second network.

Preferably, the first interface module includes an application layer using the message, a network layer and a universal asynchronous receiver and transmitter under the control protocol, and the second interface module includes an application layer, a network layer, a data link layer, a physical layer and a universal asynchronous receiver and transmitter connected to the universal asynchronous receiver and transmitter of the first interface module under the control protocol.

Preferably, the first network uses a dedicated medium and is comprised of one of RS232C, RS485 and USB.

Preferably, the second network uses a shared medium and is comprised of one of RF, PLC and IrDA.

According to another aspect of the invention, an interface apparatus of a home network system includes: a first interface module based on a predetermined control protocol connectable to a first network connected to the home network system, for transmitting/receiving a message to/from a control means of a home appliance composing the home network system; and a second interface module based on the control protocol connected to the first interface module, disconnected from the first network, and connectable to a second network connected to the home network system.

Preferably, the interface apparatus is connected to the home network system through the first interface module or the first and second interface modules according to a communication method of the home network system.

Preferably, the first and second interface modules each respectively include an application layer using the message, a network layer, a data link layer and a physical layer under the control protocol, and the data link layers each respectively include a universal asynchronous receiver and transmitter for connecting the first interface module to the second interface module.

Preferably, the first network uses a dedicated medium and is comprised of one of RS232C, RS485 and USB.

Preferably, the second network uses a shared medium and is comprised of one of RF, PLC and IrDA.

According to another aspect of the invention, an interface apparatus of a home network system includes: a first interface module for transmitting/receiving a message to/from a control means of a home appliance composing the home network system; and a second interface module based on a control protocol connected to the first interface module and connectable to a network connected to the home network system.

Preferably, the first interface module includes an application layer using the message, a network layer and a universal asynchronous receiver and transmitter under the control protocol, and the second interface module includes an application layer, a network layer, a data link layer, a physical layer and a universal asynchronous receiver and transmitter connected to the universal asynchronous receiver and transmitter of the first interface module under the control protocol.

Preferably, the network uses a shared medium and is comprised of one of RF, PLC and IrDA.

### BRIEF DESCRIPTION OF THE DRAWINGS

FIG. 1 is a structure view illustrating a general home network system;

FIG. 2 is a structure view illustrating a home network system in accordance with a preferred embodiment of the present invention;

FIG. 3 is a partial structure view illustrating a first example of a home appliance of FIG. 2;

FIG. 4 is a structure view illustrating interfaces between layers of an interface module of FIG. 3;

FIG. 5 is a structure view illustrating a frame of a universal asynchronous receiver and transmitter of FIG. 3; and

FIG. 6 is a partial structure view illustrating a second example of the home appliance of FIG. 2.

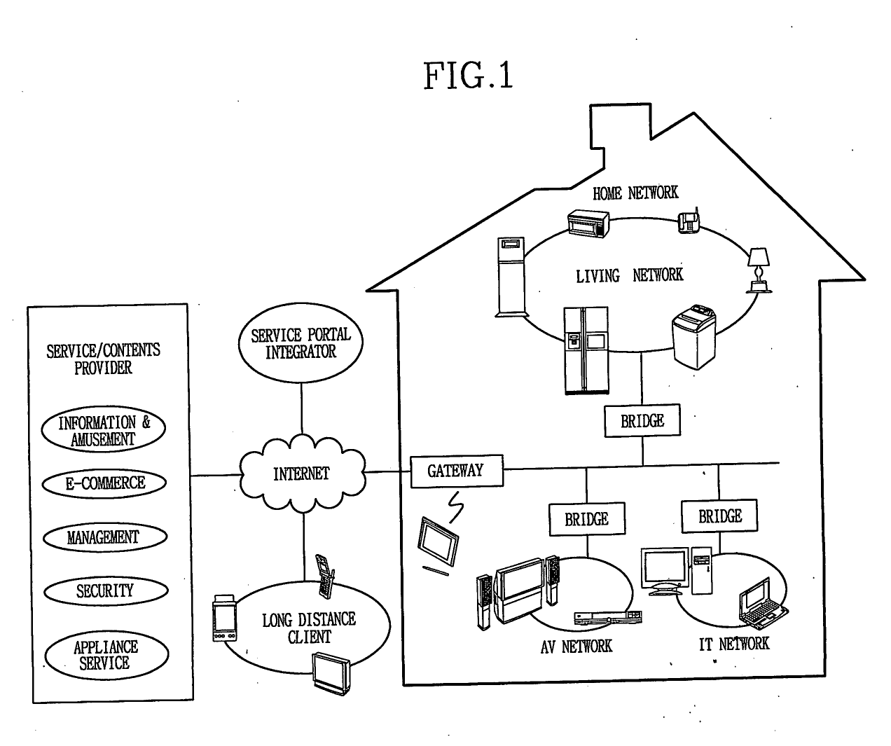

### BEST MODE FOR CARRYING OUT THE INVENTION

A home network system in accordance with the present invention will now be described in detail with reference to the accompanying drawings.

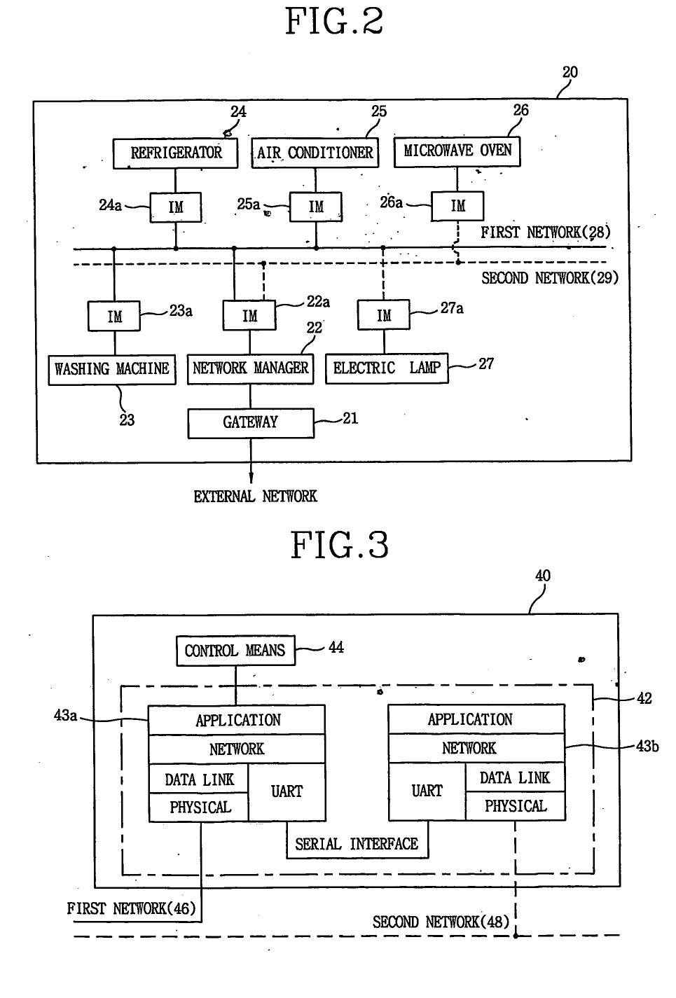

FIG. 2 is a structure view illustrating the home network system in accordance with the present invention. As illustrated in FIG. 2, the home network system 20 includes a gateway 21 connected to an external network, a network manager 22 for controlling and monitoring home appliances of the home network system 20 under a predetermined control protocol, a plurality of home appliances such as a washing machine 23, a refrigerator 24, an air conditioner 25, a microwave oven 26 and an electric lamp 27, a first network 28 for connecting the network manager 22, the washing machine 23, the refrigerator 24 and the air conditioner 25, and a second network 29 separated from the first network 28, for connecting the network manager 22, the microwave oven 26 and the electric lamp 27.

In this embodiment, the home appliances include home appliances for the living network service such as the refrigerator 23 and the washing machine 24 as well as home appliances for the IT network service and the AV network service.

The home appliances including the network manager 22 internally or externally have interface module apparatuses (hereinafter, referred to as ‘interface apparatus’) 22a, 23a, 24a, 25a, 26a and 27a to be connected to the first network 28 and/or the second network 29. In this embodiment, the built-in type interface apparatuses are exemplified. The interface apparatuses will later be explained with reference to FIG. 3.

Here, the first network 28 and the second network 29 are separated physically and/or logically. The first network 28 uses a dedicated medium and is comprised of one of RS232C, RS485 and USB, and the second network 29 uses a shared medium and is comprised of one of RF, PLC and IrDA.

The network manager 22 includes the interface apparatus 22a connected to the first network 28 and the second network 29 to be connected to all the home appliances connected to the first network 28 or the second network 29, and the other home appliances respectively include the interface apparatuses 23a, 24a, 25a, 26a and 27a connectable to at least one of the first and second networks 28 and 29.

FIG. 3 is a partial structure view illustrating a first example of the home appliance of FIG. 2. As shown in FIG. 3, the home appliance 40 (including the network manager 22) is comprised of an interface apparatus 42 connectable to a first network 46 and/or a second network 48, and a control means 44 connected to the interface apparatus 42, for controlling the whole home appliances to execute commands.

The interface apparatus 42 includes a first interface module 43a connected directly to the control means 44 and connectable to the first network 46, and a second interface module 43b connected to the first interface module 43a and connectable to the second network 48.

The first and second interface modules 43a and 43b pursue to a control protocol comprised of an application layer, a network layer, a data link layer, a physical layer, and a universal asynchronous receiver and transmitter (UART) for connecting the first and second interface modules 43a and 43b.

The physical layer of the control protocol of the first interface module 43a receives bit signals on the first network 46 and the second network 48 which are communication lines and transmits the signals to the data link layer, or transmits a frame from the upper data link layer to the first network 46 and the second network 48 through bit signals. A wire transmission method including a power line or telephone line or a wireless home network transmission method including Bluetooth can be used as the physical layer.

Thereafter, at the time of reception, the data link layer composes a frame by using a data from the lower physical layer and transmits the frame to the upper network layer, and at the time of transmission, the data link layer composes a frame by using a packet from the upper network layer and transmits the frame to the physical layer.

At the time of transmission, the network layer generates a packet by using an application layer protocol data unit (APDU) from the application layer and transmits the packet to the data link layer, and at the lime of reception, the network layer extracts an APDU from a packet data from the data link layer and transmits the APDU to the application layer.

At the time of transmission, the application layer receives information or a command of the user from the control means 44, generates a message and transmits the message to the lower network layer, and at the time of reception, the application layer interprets a message from the lower network layer and transmits the interpreted message to the control means 44.

The UART is connected to the UART of the second interface module 43b through a serial interface for access to the second network 48. At the time of transmission, the UART transmits a packet from the upper network layer through the serial interface in 10 bit frame units, and at the time of reception, the UART extracts a packet from a received frame and transmits the packet to the network layer, which is called an asynchronous serial communication function.

The UART, data link and physical layer of the second interface module 43b perform the same functions as those of the first interface module 43a. In addition, the second interface module 43b includes an application layer and a network layer to directly process a message from the control means 44 for controlling and monitoring the second interface module 43b. The second interface module 43b accesses the second network 48 which is a shared medium, and thus essentially decides which home network system a control command from an external network is transmitted to (for example, interpretation of home codes), and which home appliance the control command relates to. Accordingly, the second interface module 43b is provided to solve problems which may occur in use of the shared medium.

When the first interface module 43a of the interface apparatus 42 is connected to the first network 46, the command from the control means 44 is transmitted to the first network 46 through the application layer, network layer, data link layer and physical layer of the first interface module 43a at the time of transmission, and received in an inverse order at the time of reception. In addition, when the second interface module 43b is connected to the second network 48, the command from the control means 44 is transmitted to the UART of the second interface module 43b through the application layer, network layer and UART of the first interface module 43a, transmitted to the network layer, and transmitted to the application layer, or transmitted to the second network 48 through the data link layer and the physical layer at the time of transmission, and received in an inverse order at the time of reception. In the case that the first and second interface modules 43a and 43b are connected respectively to the first and second networks 46 and 48, the command from the control means is transmitted/received through the first and second networks 46 and 48.

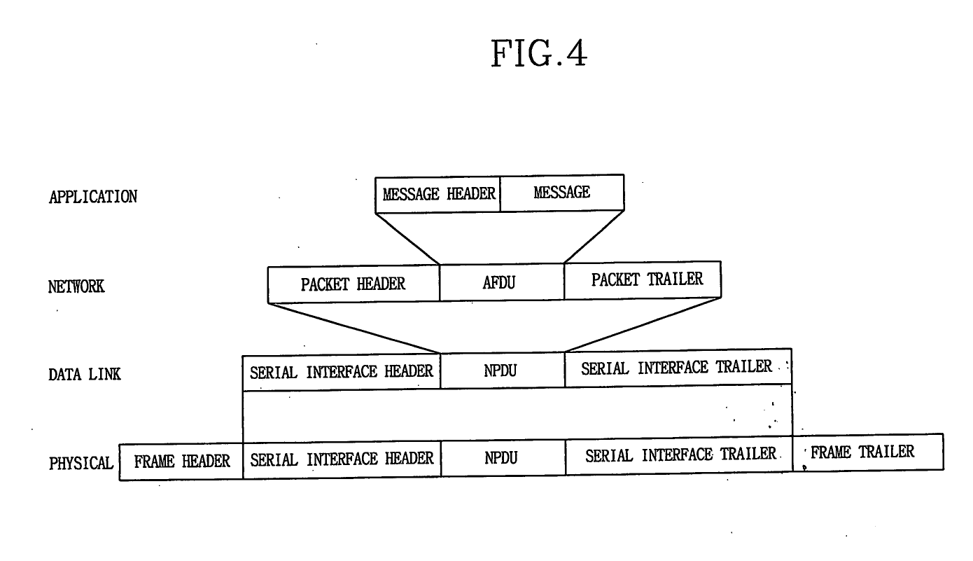

FIG. 4 is a structure view illustrating interfaces between the layers of the interface module of FIG. 3. The interface between the layers generates a new protocol data unit (PDU) to be transmitted to the lower layer by adding header or trailer information to the PDU from the upper layer.

The interfaces between the layers are formed in an APDU between the application layer and the network layer, an NPDU between the network layer and the data link layer, and a data frame unit between the data link layer and the physical layer.

The data units generated in each layer have headers. For example, when the network layer receives an APDU from the application layer, the network layer generates an NPDU by adding a packet header and a trailer containing its address, an address of a destination home appliance and a kind of a packet including importance of a transmitted message to the APDU, and transmits the NPDU to the data link layer. In the same manner, when the data link layer receives the NPDU from the upper network layer, the data link layer generates a frame to be transmitted to the physical layer by adding a serial interface header and a frame trailer to the NPDU.

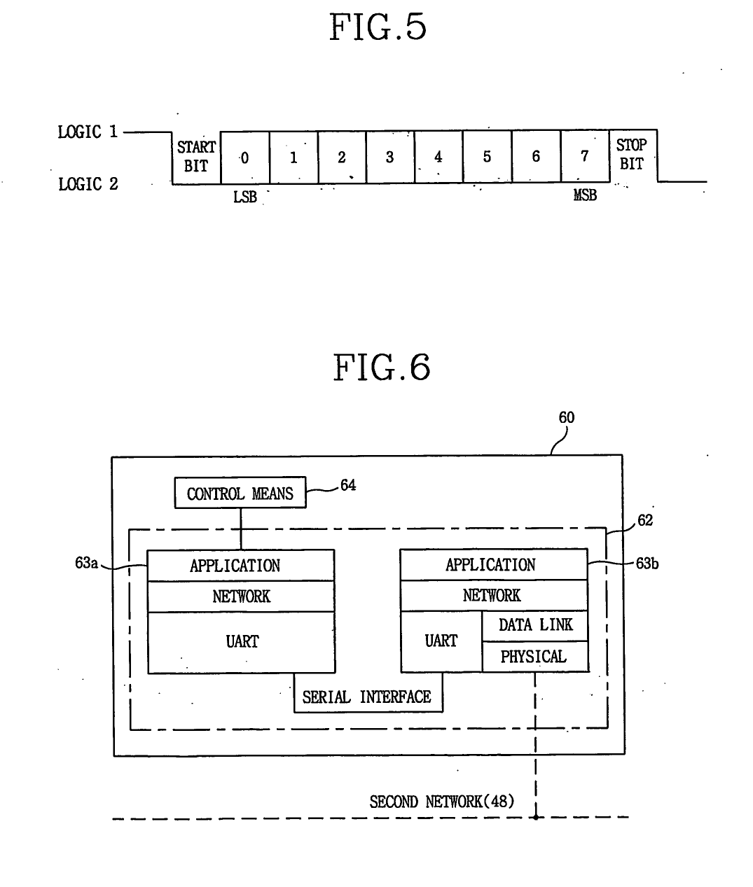

FIG. 5 is a structure view illustrating the frame of the UART of FIG. 3. As illustrated in FIG. 5, the frame of the UART is comprised of 1 bit of start bit corresponding to a header, 8 bits of data, and 1 bit of stop bit corresponding to a trailer, and does not use a parity bit. The frame is synchronized with a communication frequency, and transmitted in the order of the start bit to the stop bit.

FIG. 6 is a partial structure view illustrating a second example of the home appliance of FIG. 2. Referring to FIG. 6, the home appliance 60 includes an interface apparatus 62 for access to the second network 68, and a control means 64 for processing a predetermined control command.

The interface apparatus 62 includes a first interface module 63a connected to the control means 64, and a second interface module 63b being connected to the first interface module 63a and accessing the second network 48. The second interface module 63b is identical to the second interface module 43b of FIG. 3, but the first interface module 63a does not include a data link layer and a physical link layer differently from the first interface module 43a of FIG. 3. Accordingly, the home appliance 60 internally or externally including the interface apparatus 62 is configured not to access the first network 46. Such an interface apparatus 62 can be used when the home appliance 60 cannot be or needs not be directly interfaced with the first network. For example, in the case of the electric lamp 27 whose on/off status is merely controlled, its home appliance structure is too simple to be interfaced with a special dedicated medium such as the first network. Therefore, the interface apparatus 62 can be preferably used.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A home network system, comprising:
a first network;
a second network separated from the first network;
a home appliance connectable to at least one of the first and second networks; and
a network manager connectable to at least one of the first and second networks, for controlling and monitoring the home appliance.

2. The system of claim 1, wherein the home appliance and the network manager each respectively comprise a first interface module based on a predetermined control protocol connectable to the first network, for transmitting/receiving a message to/from an inside control means.

3. The system of claim 2, wherein the home appliance and the network manager each respectively comprise a second interface module based on the control protocol connected to the first interface module and connectable to the second network.

4. The system of claim 3, wherein the home appliance and the network manager are connected to each other through the first network by the first interface module, or through the second network by the first and second interface modules.

5. The system of claim 2 or 3, wherein the first and second interface modules each respectively comprise an application layer using the message, a network layer, a data link layer and a physical layer under the control protocol, and the data link layers each respectively comprise a universal asynchronous receiver and transmitter for connecting the first interface module to the second interface module.

6. The system of claim 1, wherein the home appliance comprises:
a first interface module for transmitting/receiving a message to/from an inside control means; and
a second interface module based on a predetermined control protocol connected to the first interface module and connectable to the second network.

7. The system of claim 6, wherein the first interface module comprises an application layer using the message, a network layer and a universal asynchronous receiver and transmitter under the control protocol, and the second interface module comprises an application layer, a network layer, a data link layer, a physical layer and a universal asynchronous receiver and transmitter connected to the universal asynchronous receiver and transmitter of the first interface module under the control protocol.

8. The system of one of claims 1 to 4, wherein the first network uses a dedicated medium.

9. The system of claim 8, wherein the first network is comprised of one of RS232C, RS485 and USB.

10. The system of one of claims 1 to 4 or 6, wherein the second network uses a shared medium.

11. The system of claim 10, wherein the second network is comprised of one of RF, PLC and IrDA.

12. An interface apparatus of a home network system, comprising:
a first interface module based on a predetermined control protocol connectable to a first network connected to the home network system, for transmitting/receiving a message to/from a control means of a home appliance composing the home network system; and
a second interface module based on the control protocol connected to the first interface module, disconnected from the first network, and connectable to a second network connected to the home network system.

13. The apparatus of claim 12, which is connected to the home network system through the first interface module or the first and second interface modules according to a communication method of the home network system.

14. The apparatus of claim 13, wherein the first and second interface modules each respectively comprise an application layer using the message, a network layer, a data link layer and a physical layer under the control protocol, and the data link layers each respectively comprise a universal asynchronous receiver and transmitter for connecting the first interface module to the second interface module.

15. The apparatus of one of claims 12 to 14, wherein the first network uses a dedicated medium.

16. The apparatus of claim 15, wherein the first network is comprised of one of RS232C, RS485 and USB.

17. The apparatus of one of claims 12 to 14, wherein the second network uses a shared medium.

18. The apparatus of claim 17, wherein the second network is comprised of one of RF, PLC and IrDA.

19. An interface apparatus of a home network system, comprising:
a first interface module for transmitting/receiving a message to/from a control means of a home appliance composing the home network system; and
a second interface module based on a control protocol connected to the first interface module and connectable to a network connected to the home network system.

20. The apparatus of claim 19, wherein the first interface module comprises an application layer using the message, a network layer and a universal asynchronous receiver and transmitter under the control protocol, and the second interface module comprises an application layer, a network layer, a data link layer, a physical layer and a universal asynchronous receiver and transmitter connected to the universal asynchronous receiver and transmitter of the first interface module under the control protocol.

21. The apparatus of claim 19 or 20, wherein the network uses a shared medium.

22. The apparatus of claim 21, wherein the network is comprised of one of RF, PLC and IrDA.
